(19) United States
(12) Patent Application Publication
(10) Pub. No.: US 2023/0156035 A1
(43) Pub. Date: May 18, 2023

(54) METHOD AND APPARATUS FOR DETECTING DDoS ATTACKS

(71) Applicant: WINS Co., Ltd., Seongnam-si (KR)

(72) Inventors: Ji Baek PARK, Seoul (KR); Myeong Hwan CHA, Yongin-si (KR)

(21) Appl. No.: 17/664,396

(22) Filed: May 20, 2022

(30) Foreign Application Priority Data
Nov. 17, 2021 (KR) 10-2021-0158854

(51) Int. Cl. H04L 9/40

(52) U.S. Cl. CPC H04L 63/1458; H04L 63/0236; H04L 63/1416; H04L 63/1425

(57) ABSTRACT

Disclose are a method and apparatus for detecting DDoS attacks. The DDoS attack detection method of a DDoS attack detection apparatus may include detecting distributed denial-of-service (DDoS) attack and, more particularly, include detecting unknown DDoS attack patterns provided in similar forms on the Internet network and controlling packet transmission or reception.

### CROSS REFERENCE TO RELATED APPLICATION(S)

This application is based on and claims priority under 35 U.S.C. 119 to Korean Patent Application No. 10-2021-0158854, filed on Nov. 17, 2021, in the Korean Intellectual Property Office, the disclosure of which is herein incorporated by reference in its entirety.

### BACKGROUND OF THE INVENTION

### 1. Field of the Invention

The present disclosure relates to a method and apparatus for detecting distributed denial-of-service (DDoS) attack and, more particularly, to a method and apparatus for detecting unknown DDoS attack patterns provided in similar forms on the Internet network, and controlling packet transmission or reception.

### 2. Description of the Prior Art

A DDoS attack that a hacker uses on an Internet network may include various types of attacks including the massive amount of traffic, an amplification attack that disrupts a service, and the like. According to a conventional packet control scheme for a DDoS attack, a pattern is verified via sequential comparison in stages and thus, the conventional method may show inflexible performance in network equipment that is required to quickly process the massive amount of traffic.

For example, a conventional sequential verification method with respect to a DDoS attack packet may detect an attack by performing sequential comparison between a received packet and N prepared patterns in stages. According to the method, if the received packet includes patterns up to an N-1^{th} pattern and excludes an N^{th} pattern, this is not regarded as an attack packet, and thus, a large amount of search resources for detecting an attack may be wasted. Therefore, the method may be used for a packet in which similar patterns are repetitive but not continuous, but efficiency and quickness of attack detection with respect to a large amount of packets may deteriorate.

In addition, for example, a conventional regular expression verification method with respect to a DDoS attack packet may be a method of processing a received packet using a regular expression in order to inspect a complex pattern at once. This method expresses a complex pattern using a regular expression, and repeatedly inspect whether patterns included in the regular expression are included in the received packet and thus, a system load is high. In addition, in the case of detection of a header or the like, if a regular expression includes repetitive inspection with respect to a small packet, the number of operations associated with repetitive operation increases and a system load increases, which is a drawback. In addition, when the complexity of the regular expression increases, the amount of time spent in analyzing the packet increases, which is a drawback.

### SUMMARY OF THE INVENTION

The present disclosure has been made in order to solve the above-mentioned problems in the prior art, and an aspect of the present disclosure is to provide a DDoS attack detection method and apparatus which are to efficiently and effectively defend against a DDoS attack having a complex pattern, and which determine whether a feature pattern is included in a received packet, given that a received packet has an identical or similar feature pattern at a predetermined index (location) in many cases, so as to detect unknown DDoS attack patterns in similar forms and to control packet transmission or reception.

In accordance with an aspect of the present disclosure, there is provided a DDoS attack detection method by a DDoS attack detection apparatus, the method including an operation of storing a predetermined pattern and a predetermined mask associated with each block of an object for which detection is to be performed, and producing an offset bitmask and a matching mode that correspond to the mask for each block; and an operation of determining whether the pattern matches each sequential block associated with a received packet, wherein the operation of determining whether the pattern and the block match may include an operation of determining whether a result of comparison between the block of the received packet and the pattern is identical to the offset bitmask in a byte matching mode among matching modes; and an operation of determining whether a result of comparison between the pattern and a result of an operation performed on the mask and block of the received packet is identical to the offset bitmask in a bit matching mode among the matching modes.

The size of the block may be dynamically determined for each block of the received packet.

The byte matching mode or the bit matching mode may be dynamically determined for each block of the received packet.

The operation of producing may include an operation of producing the offset bitmask by using a value of 0 when a byte value of the mask is a hexadecimal number of 00, and using a value compressed into 1 for other byte values.

The operation of producing may include an operation of determining the byte matching mode as the matching mode if all byte values of the mask correspond to a hexadecimal number of 00 or FF, and an operation of determining the bit matching mode as the matching mode for other cases.

In the bit matching mode, it is preferable that the operation performed on the mask and the block is a vector AND operation between byte values.

In the byte matching mode and the bit matching mode, the result of comparison with the pattern may be a comparison result (vector CMP result) association with whether byte values of the pattern match.

In the operation of determining whether the pattern and the block match, the byte matching mode or the bit matching mode may be performed on each sequential block of the received packet according to the matching mode at each of indices corresponding to an index length of the offset bitmask, and it is determined that an attack pattern is detected if the pattern and the block of the received packet match at all indices corresponding to the index length.

In accordance with an aspect of the present disclosure, there is provided a DDoS attack detection apparatus on a network, the apparatus including a policy managing unit configured to store a predetermined pattern and a predetermined mask associated with each block of an object for which detection is to be performed, and to produce an offset bitmask and a matching mode that correspond to the mask associated with each block; and a packet processing unit configured to determine whether the pattern and each sequential block of a received packet match, and according to the matching mode, to perform a byte matching mode for determining whether a result of comparison between the block of the received packet and the pattern is identical to the offset bitmask, and to perform a bit matching mode for determining whether a result of comparison between the pattern and a result of an operation performed on the mask and the block of the received packet is identical to the offset bitmask.

According to a DDoS attack detection method and apparatus according to the present disclosure, a DDoS attack having an unknown complex pattern in a similar form may be efficiently and effectively detected and prevented by determining whether a received packet has a feature pattern at a predetermined index (location), and thus, it is guaranteed that packet transmission or reception may smoothly flow in a system such as a server or the like on the Internet network. That is, when traffic is provided, most various DDoS traffic on a general-purpose network where network traffic may rapidly increase may have a feature pattern in which the value of a predetermined index (location) is repeated similarly as shown in FIG. 1. By efficiently and effectively detecting feature patterns in repetitive and similar forms with respect to an indiscriminate DDoS attack according to a multi mask matching (MMM) scheme, the limit of a system resource may be overcome so as not to affect system availability, and stability of a network may be secured.

In addition, according to a DDoS attack control detection method and apparatus according to the present disclosure, repetitive short packet communication on network communication may be controlled (repetitive inspection on a small packet in the case of detection of a header or the like), and even when a complex pattern is included in data having a high payload, a feature pattern may be detected in high speed and a DDoS attack may be efficiently and effectively prevented.

In addition, according to a DDoS attack control detection method and apparatus according to the present disclosure, the number of digits of an offset bitmask applied to detection of a feature pattern may be optimized by increasing/decreasing the number of digits depending on a computing environment, and thus, upward/downward compatibility may be flexibly managed. By applying a dynamic function, as opposed to a static function, to the detection of a feature pattern, an unknown urgent situation can be promptly handled without affecting system availability.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a diagram illustrating a feature pattern that is similarly repeated in traffic on a normal network;

FIG. 2 is a diagram illustrating the configuration of a DDoS attack detection apparatus according to an embodiment of the present disclosure;

FIG. 3 is a diagram illustrating a pattern desired to be detected, a mask, an offset bitmask, and a matching mode applied to a policy managing unit of FIG. 2;

FIG. 4 is a diagram illustrating a filtering setting in a filtering unit 121 of FIG. 2;

FIG. 5 is a diagram illustrating a setting of the start location of a packet for which detection is to be performed, in the layer setting unit 122 of FIG. 2;

FIG. 6 is a diagram illustrating an operation method in a byte matching mode and an operation method in a bit matching mode in a matching determining unit of FIG. 2;

FIG. 7 is a flowchart illustrating an attack pattern detection determining method in the matching determining unit of FIG. 2;

FIG. 8 is a diagram illustrating an example in which a DDoS attack detection apparatus is embodied in an attack target server (VICTIM) and handles a spoofing attack from an attacker according to an embodiment of the present disclosure; and

FIG. 9 is a diagram illustrating an example of a method of embodying a DDoS attack detection apparatus according to an embodiment of the present disclosure.

### DETAILED DESCRIPTION OF THE EXEMPLARY EMBODIMENTS

Hereinafter, the present disclosure will be described in detail with reference to attached drawings. In this instance, like reference numerals may refer to like elements illustrated in the accompanying drawings. In addition, detailed descriptions related to a well-known function or configuration will be omitted herein. The disclosure provided below will mainly describe the part needed to understand operations according to various embodiments, and descriptions of elements which make the subject matter of the descriptions unclear will omitted. In addition, some elements of the drawings may be omitted, or may be illustrated exaggeratingly or roughly. The size of each element does not reflect the actual size of the element, and thus, the disclosure is not limited to the relative sizes of elements or spacing therebetween illustrated in the drawings.

When detailed descriptions related to a well-known related function are determined to make the subject matter of the present disclosure ambiguous, the detailed descriptions thereof will be omitted herein. The terms to be described below are terms defined in consideration of functions in the present disclosure, and may be changed by a user, intention of an operator, custom, or the like. Therefore, the definitions of the terms should be made based on the contents throughout the specification. The terms used in the detailed description is for the purpose of describing embodiments of the present disclosure only and is not intended to be restrictive. The singular forms are intended to include the plural forms as well, unless the context clearly indicates otherwise. It will be understood that the terms “comprises”, or “includes”, when used in this description, specify the presence of stated features, numbers, steps, operations, elements, and/or part or a combination thereof, but do not preclude the presence or possibility of one or more other features, numbers, steps, operations, elements, and/or part or combination thereof.

It will be further understood that although the terms first, second, or the like, may be used herein to describe various elements, these elements should not be limited by these terms, and these terms are only used to distinguish one element from another element.

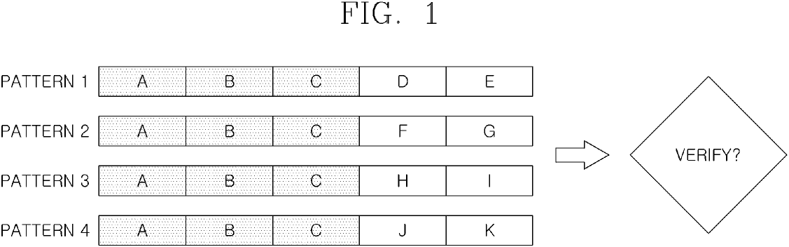

FIG. 1 is a diagram illustrating a feature pattern that is similarly repeated in traffic on a normal network.

Referring to FIG. 1, when traffic is provided, most various indiscriminate DDoS attack traffic on a general-purpose network where traffic rapidly increases in a network such as the Internet may have a feature pattern (A, B, C, ...) in which the value of a predetermined index (location) is repeated similarly as shown in FIG. 1. By efficiently and effectively inspecting and detecting a feature pattern (A, B, C, ...) provided in a repetitive and similar form with respect to an indiscriminate DDoS attack according to a multi mask matching (MMM) scheme, the limit of a system resource may be overcome so as not to affect system availability and stability of a network may be secured. In addition, the present disclosure may control repetitive short packet communication in network communication, and even when a complex pattern is included in data having a high payload, may detect a feature pattern at high speed and may efficiently and effectively defend against a DDoS attack.

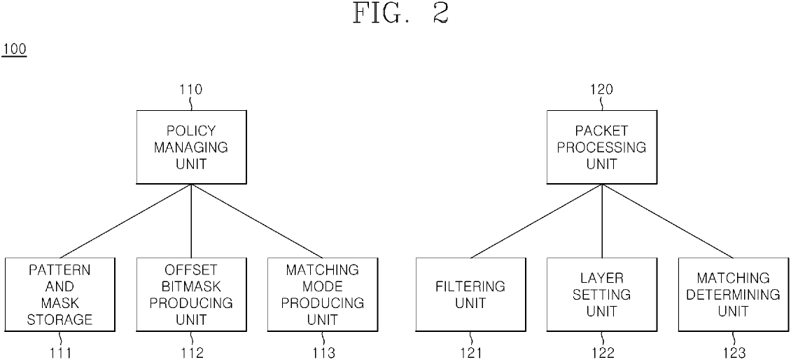

FIG. 2 is a diagram illustrating the configuration of a DDoS attack detection apparatus 100 according to an embodiment of the present disclosure.

Referring to FIG. 2, the DDoS attack detection apparatus 100 on a network such as the Internet or the like according to an embodiment of the present disclosure may include a policy managing unit 110 and a packet processing unit 120 which interoperate, having an interdependent relationship, as opposed to an independent relationship. The policy managing unit 110 for managing policy information associated with a DDoS attack, such as a pattern, a mask, and the like set by a policy manager, and for providing detection policy information, such as a offset bitmask, a matching mode, and the like, to the packet processing unit 120, may include a pattern and mask storage 111, an offset bitmask producing unit 112, and a matching mode producing unit 113. The packet processing unit 120 for detecting a DDoS attack of a packet received on a network such as the Internet or the like, and for controlling the transmission or reception of the packet may include a filtering unit 121, a layer setting unit 122, and a matching determining unit 123.

The above-described elements of the DDoS attack control apparatus 100 according to an embodiment of the present disclosure that may be contained in a server in a network such as the Internet or the like may be embodied as hardware such as a semiconductor processor, software such as application programs, or a combination thereof.

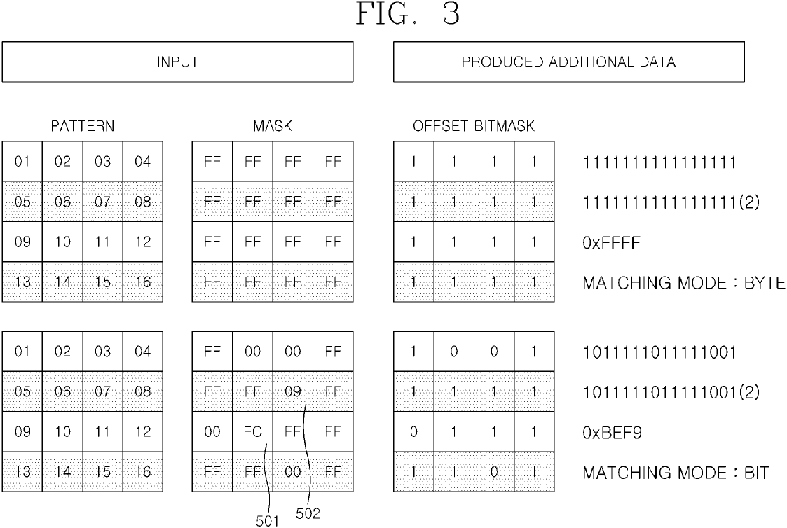

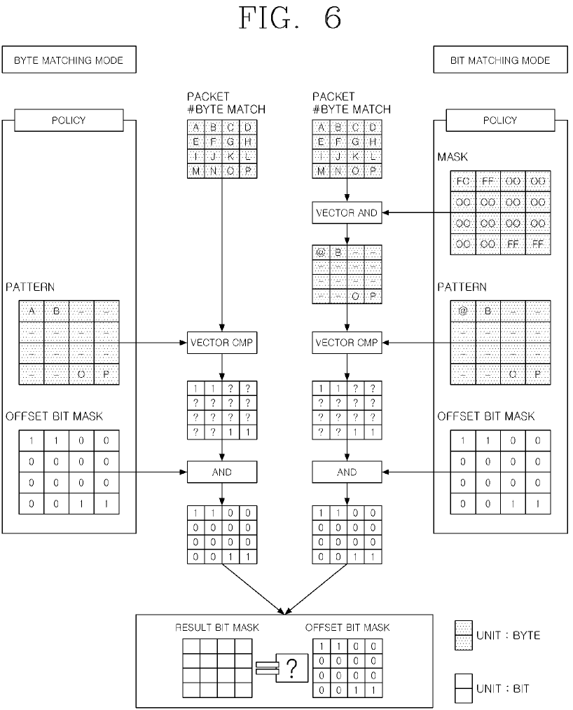

The pattern and mask storage 111 of the policy managing unit 110 may store policy information associated with a DDoS attack, such as a predetermined pattern and a predetermined mask (refer to FIG. 3 and FIG. 6) associated with each block (e.g., 16 bytes) of an object for which detection is to be performed, with respect to a received packet received in the network such as the Internet or the like. A user such as the policy manager or the like may predict similar attack patterns (refer to FIG. 1) having a feature pattern based on an indiscriminate DDoS attack, and may store, in the storage unit 111, a predetermined pattern and a predetermined mask of digital information corresponding to the header or payload of a received packet, and may maintain the same. Although FIG. 3 and FIG. 6 illustrate examples in which the pattern and the mask include a 16 byte-block, the present disclosure is not limited thereto. Depending on an environment or a design, the pattern and mask may store and maintain digital information by determining the pattern and the mask to have one of the various byte sizes which is fewer or greater than 16 bytes, such 1, 2, 3, ... or the like. As described above, the size of a block for which detection is to be performed, that is, a block size (byte) may be dynamically determined for each block of a received packet. That is, the byte size of each block 1, 2, 3, ... and the like is not determined to be one size (e.g., 16 bytes), and different sizes may be alternately, periodically, or irregularly combined and applied.

The offset bitmask producing unit 112 of the policy managing unit 110 may produce an offset bitmask (refer to FIG. 3 and FIG. 6) corresponding to the mask for each block of a received packet, as detection policy information to be transmitted to the packet processing unit 120. The matching mode producing unit 113 of the policy managing unit 110 may produce a matching mode corresponding to the mask for each block of a received packet, as detection policy information to be transmitted to the packet processing unit 120.

FIG. 3 is a diagram illustrating a pattern desired to be detected, a mask, an offset bitmask, and a matching mode applied to the policy managing unit 110 of FIG. 2.

Referring to FIG. 3, a user such as a policy manager or the like may predict similar attack patterns (refer to FIG. 1) having a feature pattern based on an indiscriminate DDoS attack, and may store a predetermined pattern (e.g., a 16-byte block) of digital information corresponding to the header or payload of a received packet in advance in the storage unit 111, and may store a predetermined mask (e.g., a 16-byte block) corresponding thereto in advance in the storage unit 111.

The offset bitmask producing unit 112 may produce an offset bitmask corresponding to the mask for each block of a received packet. For example, in the example of FIG. 3, the offset bitmask producing unit 112 may produce the offset bitmask by using 0 when the byte value of a mask is a hexadecimal number of 00, and by using a value compressed into 1 for other cases. As shown in diagrams 501 and 502 of FIG. 3, when the byte value of a mask is a hexadecimal number of 09, FC, or the like, the byte value is different from a hexadecimal number of 00 and thus, a value compressed into 1 may be used as shown in the offset bitmask illustrated in the right side of the drawing. In the example of FIG. 3, if the value of the offset bitmask is 1111111111111111, 1111111111111111 may be expressed as a binary number of 1111111111111111(₂). Therefore, the value may be a mask which allows a 16-digit index masking operation. If the result calculated as the value of the offset bitmask is 1111111111111101(₂), that may be a mask having a meaning that a second-digit having a value of 0 in a packet is not to be verified. In the example in the lower side of FIG. 3, as shown in the case in which the result calculated as the value of the offset bitmask is OxBEF9, second, third, ninth, and fifteenth digits of a packet have a value of 0 and thus, the corresponding part in the mask is not to be verified. As shown in diagrams 501 and 502 of FIG. 3, if the byte value of a mask is a hexadecimal number of 09, FC, and the like, a part where the bit value is different from 0 is to be verified in detail. In this manner, if a 16-digit bit is expressed in the form of a hexadecimal number, it is compressed into 0xFFFF. This may be expressed in 2 bytes in a computer data structure, and thus, may be stored in a short variable.

The matching mode producing unit 113 may produce a matching mode corresponding to the mask for each block of a received packet. For example, as illustrated in FIG. 3, when all byte values in the mask correspond to a hexadecimal number of 00 or FF, the matching mode producing unit 113 may determine a byte matching mode as the matching mode, and may output a corresponding flag value. Otherwise, the matching mode producing unit 113 may determine a bit matching mode as the matching mode, and may output a corresponding flag value. In the example in the upper side of FIG. 3, the case in which all byte values of the mask correspond to a hexadecimal number of FF corresponds to a byte matching mode. In the example in the lower side of FIG. 3, as shown in diagram 501 and 502, all byte values of the mask include a hexadecimal number of 09, FC, and the like in addition to a hexadecimal number of 00 or FF, and this case corresponds to a bit matching mode. In this instance, this means that a part where a bit value is different from 0 is to be verified in detail (a part where a bit value is 0 is not to be verified), in a value of 09 and FC in diagrams 501 and 502.

Here, the byte matching mode or the bit matching mode may be dynamically determined for each block in the flow of a received packet. That is, the byte matching mode or the bit matching mode may not be uniformly determined for each block 1, 2, 3, ..., and the like, and the bite matching mode and the bit matching mode may be may be alternately, periodically, or irregularly combined and applied.

In order to detect a DDoS attack of a packet received on a network such as the Internet or the like, and to control the transmission or reception of the packet, the filtering unit 121 of the packet processor 120 may filter a size and a flow of a received packet for which detection is to be performed.

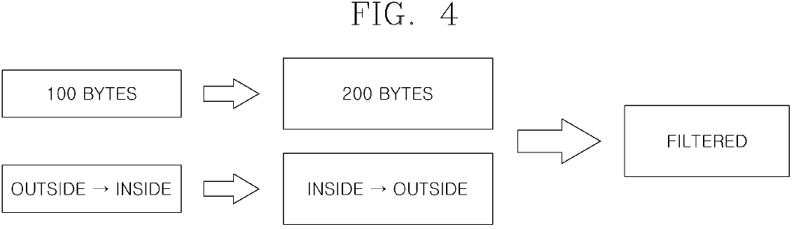

FIG. 4 is a diagram illustrating a filtering setting in the filtering unit 121 of FIG. 2. For example, if the size of a received packet for which detection is to be performed is greater than or equal to 100 bytes, 200 bytes, or the like, the filtering unit 121 may set an object for which detection is to be performed by distinguishing the case in which the received packet is a packet that flows from an external system into an internal system, the case in which the received packet is a packet that flows from the internal system into the external system, and the like. In this instance, the filtering unit 121 may control an environmental effect so that the received packet is to be processed as an object for which detection is to be performed in the matching determining unit 123.

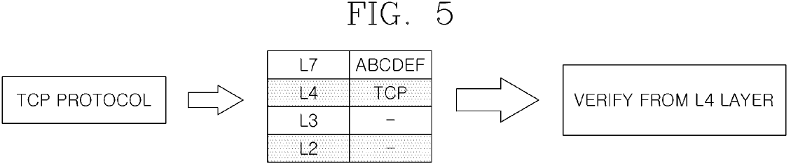

FIG. 5 is a diagram illustrating a setting of the start location of a packet for which detection is to be performed, in the layer setting unit 122 of FIG. 2.

Referring to FIG. 5, the layer setting unit 122 of the packet processing unit 120 may control the verification start point (L2/L3/L4/L7) of a policy based on, for example, four layers of TCP/IP (transmission control protocol/internet protocol). For example, based on a verification start point set in advance in the layer setting unit 122, the matching determining unit 123 may perform control so that a received packet is to be processed as an object for which detection is to be performed in the matching determining unit 123, from the start point of a corresponding header part such as L2, L3, L4, and L7 layers and the like. In addition, depending on the case, the verification start point set in advance may be set to an arbitrary location, such as a location that is a predetermined byte distant from the location where the header of a received packet starts, or the like, and the matching determining unit 123 may detect whether an attack is present such as determining whether a received packet is matched from the corresponding verification start point.

FIG. 6 is a diagram illustrating an operation method in a byte matching mode and an operation method in a bit matching mode, performed by the matching determining unit 123 of FIG. 2.

Referring to FIG. 6, the matching determining unit 123 of the packet processing unit 120 may apply a setting of a packet, for which detection is to be performed, of the filtering unit 121 and a setting of a verification start point of the layer setting unit 122, and may determine whether each sequential block (e.g., 16 bytes) of a received packet for which detection is to be performed matches a pattern in the pattern and mask storage 111.

That is, according to a matching mode set in the matching mode producing unit 113, in the byte matching mode, the matching determining unit 123 may determine (e.g., using an AND operation) whether a result of comparison between the block of the received packet and the pattern (e.g., using a Vector CMP operation) matches an offset bitmask from the offset bitmask producing unit 112. According to a matching mode set in the matching mode producing unit 113, in the bit matching mode, the matching determining unit 123 may determine (e.g., using an AND operation) whether a result of comparison (e.g., using a Vector CMP operation) between the pattern and a result of an operation (e.g., using a Vector AND operation) performed on the mask of the pattern and mask storage unit 111 and the block of the received packet matches the offset bitmask.

As illustrated in the example of FIG. 6, in the byte matching mode, the result of comparison between the block of the received packet and the pattern is a comparison result (Vector CMP) associated with whether the byte values (A, B, O, P) of the pattern match. That is, the matching determining unit 123 may use a Vector CMP operation (1 indicates ‘matched’, 0 indicates ‘non-matched’) that is associated with whether byte values (A, B, O, P) which are different from 0 in the pattern and are to be verified among the byte values (A to F) of the block of the received packet match the byte values (A, B, O, P) of the pattern at corresponding byte locations. In addition, the matching determining unit 123 may perform an AND operation on the result of the Vector CMP operation and the offset bitmask, so as to determine whether the result of the Vector CMP operation matches the offset bitmask. In the Vector CMP operation, whether the values that are compared have the same policy as that of the received packet may not be determined using the values as they are, because the comparison operation is performed on an area corresponding to a plurality of bytes, as opposed to a single byte, and garbage values (e.g., a part excluding A, B, O, P) written in a memory are also compared. Therefore, an additional operation may be needed in order to remove the garbage values. The policy managing unit 110 may perform an AND operation on a result produced using the offset bitmask, and may compare a result of the AND operation and the offset bitmask so as to identify whether they match, and may complete packet verification.

In addition, as illustrated in the example of FIG. 6, in the bit matching mode, the matching determining unit 123 may use a vector AND operation on mutually corresponding byte values when performing an operation on the mask of the pattern and mask storage 111 and the block of the received packet. When comparing the pattern and the result of the Vector AND operation performed on mutually corresponding byte values, the matching determining unit 123 may use a Vector CMP operation that is associated with whether the byte values (@, B, O, P) of the pattern are matched at corresponding byte locations. In addition, the matching determining unit 123 may perform an AND operation on the result of the Vector CMP operation and the offset bitmask, so as to determine whether the result of the Vector CMP operation matches the offset bitmask. As described above, although the bit matching scheme is similar to the byte matching scheme, the bit matching scheme additionally includes, as a preprocessing process, a vector AND operation between the value of the mask and the block of the received packet. According to the present disclosure, by supporting the bit matching scheme in addition to the byte matching scheme, a bit pattern of a predetermined protocol of a packet on a network may be verified. For example, a TCP flag field includes 6 bits (URG, ACK, PSH, RST, SYN, FIN). By supporting the bit matching scheme, detail packet verification (whether a packet is matched or the like) may be performed in a bit level using a pattern associated with a flag or a combination of two or more flags.

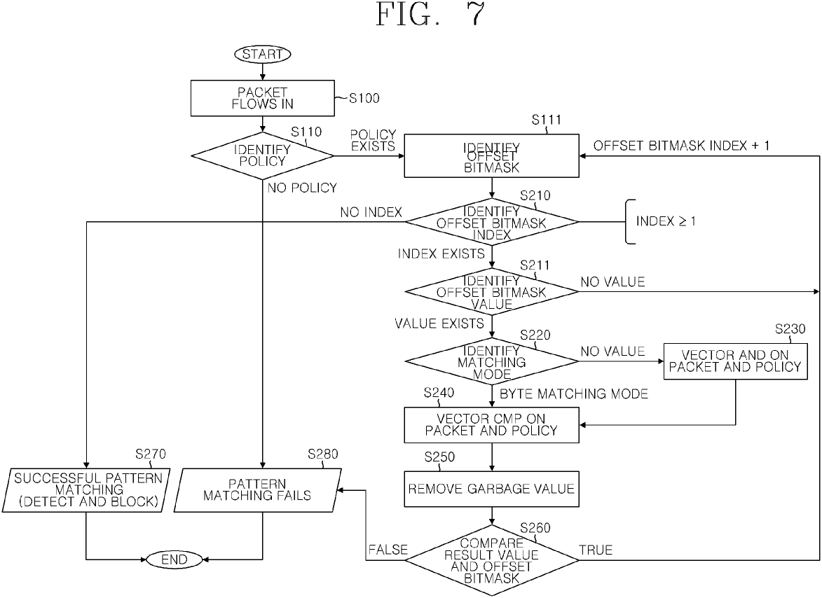

Hereinafter, a DDoS attack detection method by the DDoS attack detection apparatus 100 of the present disclosure will be described with reference to the flowchart of FIG. 7.

FIG. 7 is a flowchart illustrating an attack pattern detection determining method in the matching determining unit 123 of FIG. 2.

Referring to FIG. 7, a packet flowing in is received on a network such as the Internet or the like in operation S100. In general, the size of a received packet is greater than or equal to 64 bytes. Accordingly, in order to verify a packet using a block having a size of 16 bytes as illustrated in FIG. 3, whether a pattern is matched needs to be performed via a loop processing which is repeated as long as the index length of an offset bitmask.

Subsequently, the matching determining unit 123 may identify a policy setting of the policy managing unit 110, and may apply a setting of a packet, for which detection is to be performed, of the filtering unit 121 and a verification start point setting of the layer setting unit 122 in operation S110, and may determine whether each sequential block (e.g., 16 bytes) of the corresponding received packet for which detection is to be performed matches the pattern in the pattern and mask storage 111 in operations S111 to S280. If the policy of the policy managing unit 110 is not present, the matching determining unit 123 may determine that pattern matching fails and may terminate the process in operation S280.

If the policy of the policy managing unit 110 is present, the matching determining unit 123 may verify whether the pattern is matched via a loop processing repeated as long as the index length of an offset bitmask as described below, in operations S111 to S270.

If the matching determining unit 123 identifies that the offset bitmask is present in operation S111, the matching determining unit 123 may identify the index (≥1) of the corresponding offset bitmask in operation S210, may identify the value of the offset bitmask in operation S211, may identify a matching mode S220, may perform a byte matching mode or a bit matching mode with respect to each sequential block of the received packet at each index according to the matching mode in operation S230 or S240, may remove garbage values by performing an AND operation on the offset bitmask in operation S250, and may determine that an attack pattern is detected when a result of a Vector CMP operation is identical to the offset bitmask in operation S260 as illustrated in FIG. 6. Operations S111 to S260 described above may be repeated as long as the index length of the offset bitmask by increasing an index by 1 for each time, that is, as many times as the number of blocks of the received packet that need to be verified. Accordingly, when patterns of the pattern and mask storage 111 match the blocks of the received packet at all indices, it is determined that an attack pattern is detected in operation S270.

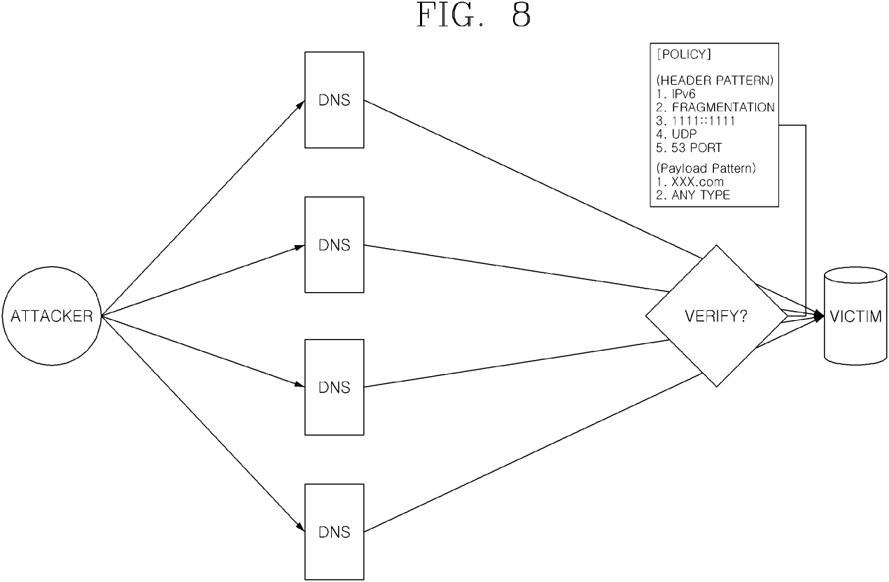

FIG. 8 is a diagram illustrating an example in which the DDoS attack detection apparatus 100 is embodied in an attack target server (VICTIM) and handles a spoofing attack from an attacker according to an embodiment of the present disclosure.

Referring to FIG. 8, the DDoS attack detection apparatus 100 according to an embodiment of the present disclosure may be contained in one of the various types of servers (VICTIM) in a network, such as the Internet or the like. A server (VICTIM) may receive a spoofing attack packet from various domain name systems (DNS). For example, if an attacker attempts an amplification attack that pretends to be headed a plurality of domain name systems (DNS) as a final destination via the spoofing attack packet, the server (VICTIM) may have an increased load of transmitting corresponding response data to the plurality of DNSs.

In the case of the spoofing attack described above, an attack that is difficult to block with a single pattern, and the like, there is a limit to defense against the DDoS. There are various defense methods, such as syn-cookie, syn-proxy, and the like, against a spoofing attack. However, although some spoofing attacks can be handled, there is a limit to defense, only using various detection/blocking methods such as regular expression and the like, against an attack which has a complex pattern and which is difficult to block using a single pattern.

According to the DDoS attack detection apparatus 100 according to the present disclosure, a DDoS attack of an attacker that has an unknown complex pattern in a similar form may be efficiently and effectively detected and prevented by determining whether a received packet has a feature pattern at a predetermined index (location) according to the above-described packet verification method, and it is guaranteed that packet transmission or reception may smoothly flow in a system such as a server or the like on an Internet network. That is, when traffic is provided, most various DDoS traffic on a general-purpose network where network traffic rapidly increases may have a feature pattern in which the value of a predetermined index (location) is repeated similarly as illustrated in FIG. 1. By efficiently and effectively detecting a feature pattern provided in a repetitive and similar form with respect to an indiscriminate DDoS attack according to a multi mask matching (MMM) scheme, the limit of a system resource may be overcome so as not to affect system availability, and stability of a network may be secured.

In addition, the DDoS attack control detection apparatus 100 according to an embodiment of the present disclosure may control repetitive short packet communication on network communication (may repeatedly inspect on a small packet in the case of detection of a header or the like), may detect a feature pattern in high speed even when a complex pattern is included in data having a high payload, and may efficiently and effectively defend against a DDoS attack. In addition, the DDoS attack control detection apparatus 100 according to an embodiment of the present disclosure may optimize the number of digits of an offset bitmask applied to detection of a feature pattern by increasing/decreasing the number of digits depending on a computing environment, and thus, may flexibly manage upward/downward compatibility. By applying a dynamic function, as opposed to a static function, to the detection of a feature pattern, an unknown urgent situation can be promptly handled without affecting system availability.

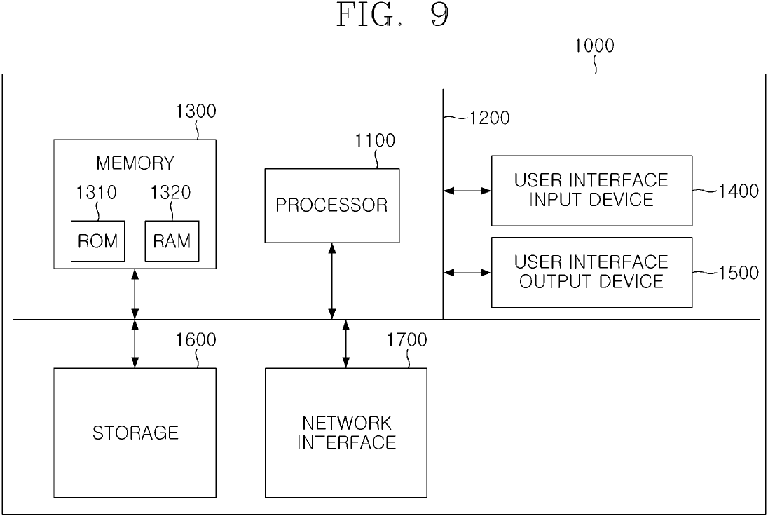

FIG. 9 is a diagram illustrating an example of a method of implementing the DDoS attack detection apparatus 100 that processes a method of detecting a DDoS attack and controls transmission or reception of a packet according to an embodiment of the disclosure.

The DDoS attack detection apparatus 100 that processes a method of detecting a DDoS attack and controlling transmission or reception of a packet may include hardware, software, or a combination thereof. For example, the DDoS attack detection apparatus 100 of the present disclosure may be embodied in the form of a computing system 1000 of FIG. 9 having at least one processor for implementing the above-described functions/steps/processes, or in the form of a server on the Internet.

The computing system 1000 may include at least one processor 1100 connected via a bus 1200, a memory 1300, a user interface input device 1400, a user interface output device 1500, a storage 1600, and a network interface 1700. The processor 1100 may be a semiconductor device that implements processing of instructions stored in a central processing unit (CPU), the memory 1300, and/or the storage 1600. The memory 1300 and the storage 1600 may include various types of volatile or nonvolatile storage media. For example, the memory 1300 may include a read only memory (ROM) 1310 and a random access memory (RAM) 1320.

In addition, the network interface 1700 may include a communication module such as a modem that supports wired Internet communication, wireless Internet communication, such as WiFi, WiBro, and the like, mobile communication such as WCDMA, LTE, and the like in a user equipment, such as a smartphone, a laptop PC, a desktop PC, and the like, or may include a communication module such as a modem that supports communication based on a short-range wireless communication scheme (e.g., Bluetooth, Zigbee, WiFi, and the like).

Therefore, the method and algorithm described in association with the embodiments disclosed in the present specification may be directly implemented by a hardware module, a software module, or a combination thereof which are executed by the processor 1100. The software module may reside in a computer or device-readable storing/recording medium (i.e., the memory 1300 and/or the storage 1600) such as a RAM memory, a flash memory, an ROM memory, an EPROM memory, an EEPROM memory, a register, a hard disk, a detachable disk, and a CD-ROM. An example of a storage medium may be coupled to the processor 1100, and the processor 1100 may read information (code) from the storage medium and may write information (code) in the storage medium. As another example, a storage medium may be embodied in the form of being integrated with the processor 1100. A processor and a storage medium may reside in an integrated circuit (ASIC). The ASIC may reside in a user equipment. As another method, a processor and a storage medium may reside in a user equipment as individual components.

Although the present disclosure have been shown and described based on predetermined items such as specific elements or the like and some embodiments and drawings, this is merely to help understanding but the present disclosure is not limited to the embodiments. Instead, it would be appreciated by those skilled in the art that various modifications and changes may be made to these embodiments without departing from the principles and spirit of the invention. Therefore, it should be understood that the idea of the present disclosure is not limited to the embodiments, and that all technical ideas that are equivalent to the scope of claims or that include equivalent modifications may fall within the scope of the example embodiments.

What is claimed is:

1. A DDoS attack detection method by a DDoS attack detection apparatus, the method comprising:
storing a predetermined pattern and a predetermined mask associated with each block of an object for which detection is to be performed, and producing an offset bitmask and a matching mode that correspond to the mask for each block; and
determining whether the pattern matches each sequential block associated with a received packet,
wherein the determining of whether the pattern and the block match comprises:
in a byte matching mode among matching modes, determining whether a result of comparison between the block of the received packet and the pattern is identical to the offset bitmask; and
in a bit matching mode among the matching modes, determining whether a result of comparison between the pattern and a result of an operation performed on the mask and block of the received packet is identical to the offset bitmask.

2. The method of claim 1, wherein a size of the block is dynamically determined for each block of the received packet.

3. The method of claim 1, wherein the byte matching mode or the bit matching mode is dynamically determined for each block of the received packet.

4. The method of claim 1, wherein the producing comprises producing the offset bitmask by using a value of 0 when a byte value of the mask is a hexadecimal number of 00, and using a value compressed into 1 for other byte values.

5. The method of claim 1, wherein the producing comprises determining the byte matching mode as the matching mode if all byte values of the mask correspond to a hexadecimal number of 00 or FF, and determining the bit matching mode as the matching mode for other cases.

6. The method of claim 1, wherein, in the bit matching mode, the operation performed on the mask and the block is a vector AND operation between byte values.

7. The method of claim 1, wherein, in the byte matching mode and the bit matching mode, the result of comparison with the pattern is a comparison result (vector CMP) association with whether byte values of the pattern match.

8. The method of claim 1, wherein the determining of whether the pattern and the block match comprises:
performing the byte matching mode or the bit matching mode to each sequential block of the received packet according to the matching mode at each of indices corresponding to an index length of the offset bitmask, and determining that an attack pattern is detected if the pattern and the block of the received packet match at all indices corresponding to the index length.

9. A DDoS attack detection apparatus on a network, the apparatus comprising:
a policy managing unit configured to store a predetermined pattern and a predetermined mask associated with each block of an object for which detection is to be performed, and to produce an offset bitmask and a matching mode that correspond to the mask associated with each block; and
a packet processing unit configured to determine whether the pattern and each sequential block of a received packet match, and according to the matching mode, to perform a byte matching mode for determining whether a result of comparison between the block of the received packet and the pattern is identical to the offset bitmask, and to perform a bit matching mode for determining whether a result of comparison between the pattern and a result of an operation performed on the mask and the block of the received packet is identical to the offset bitmask.
